(19) United States
(12) Patent Application Publication
(10) Pub. No.: US 2025/0338128 A1
(43) Pub. Date: Oct. 30, 2025

(54) SERVER AND METHOD FOR DETECTING ATTACK OF ABNORMAL MESSAGE

(71) Applicant: Samsung Electronics Co., Ltd., Suwon-si (KR)

(72) Inventors: Junho HUH, Suwon-si (KR); Hyejin SHIN, Suwon-si (KR); Sunwoo AHN, Suwon-si (KR); Hayoon YI, Suwon-si (KR); Taewoo KIM, Suwon-si (KR); Mooserk PARK, Suwon-si (KR); Minchae LIM, Suwon-si (KR); Joonho CHO, Suwon-si (KR)

(21) Appl. No.: 19/191,941

(22) Filed: Apr. 28, 2025

Related U.S. Application Data
(63) Continuation of application No. PCT/KR2025/005535, filed on Apr. 24, 2025.

(30) Foreign Application Priority Data
Apr. 29, 2024 (KR) 10-2024-0057065
Oct. 24, 2024 (KR) 10-2024-0146335

(51) Int. Cl. H04W 12/121; H04W 4/14; H04W 12/06; H04W 12/71

(52) U.S. Cl. CPC H04W 12/121; H04W 4/14; H04W 12/06; H04W 12/71

(57) ABSTRACT

According to an embodiment, a server may include: at least one processor, comprising processing circuitry, and memory configured to store instructions, wherein the instructions are configured to, when executed by the at least one processor individually or collectively, cause the server to: receive a first message for an authentication request, identify information included in the first message, acquire at least one of a first feature acquired using information related to the authentication request among information included in the first message, a second feature acquired using information related to a device and a telephone number among information included in a plurality of first messages received during a designated time period, and/or a third feature acquired using information related to a device and a telephone number among information included in a plurality of first messages received from a designated country during a designated time period, input the at least one feature to an artificial intelligence model as an input value, and based on an output value output from the artificial intelligence model being greater than or equal to a threshold value, identify the first message as an attack of an abnormal message.

### CROSS-REFERENCE TO RELATED APPLICATIONS

This application is a continuation of International Application No. PCT/KR2025/005535 designating the United States, filed on Apr. 24, 2025, in the Korean Intellectual Property Receiving Office and claiming priority to Korean Patent Application Nos. 10-2024-0057065, filed on Apr. 29, 2024, and 10-2024-0146335, filed on Oct. 24, 2024, in the Korean Intellectual Property Office, the disclosures of each of which are incorporated by reference herein in their entireties.

### BACKGROUND

### Field

The disclosure relates to a server and method for detecting an attack of an abnormal message.

### Description of Related Art

An artificially inflated traffic attack is carried out by fraudsters using bots to register fake accounts on a server and trigger a large number of fake SMS authentication requests.

A user may access the server through an electronic device or the web to register an account or perform a login, in which case the user may send an SMS authentication request to the server through an electronic device or the web.

The server may transmit an SMS through an SMS relay agency or carrier in response to an SMS authentication request, and the server pays the SMS relay agency or carrier for the cost of transmitting an SMS through the SMS relay agency or carrier.

However, SMS relay agencies or malicious carriers may collude with fraudsters to generate large volumes of fake SMS authentication requests, and may make a financial profit as the servers are asked to pay for the large volume of fake SMS traffic.

A combination of features acquired based on information included in a first massage requesting authentication may detect complex artificially inflated traffic (AIT) attacks with high accuracy and reduce false positives.

### SUMMARY

A server according to an example embodiment may include at least one processor, comprising processing circuitry, and memory configured to store instructions. According to an embodiment, the instructions, when by the at least one processor individually or collectively, may cause the server to: receive a first message for an authentication request and identify information included in the first message. According to an embodiment, the instructions, when executed by the at least one processor individually or collectively, may cause the server to acquire at least one of a first feature acquired using information related to the authentication request among information included in the first message, a second feature acquired using information related to a device and a telephone number among information included in a plurality of first messages received during a designated time period, or a third feature acquired using information related to a device and a telephone number among information included in a plurality of first messages received from a designated country during a designated time period. According to an embodiment, the instructions, when executed by the at least one processor individually or collectively, may cause the server to input the at least one feature into an artificial intelligence model as an input value. According to an embodiment, the instructions, when executed by the at least one processor individually or collectively, may cause the server to, based on an output value output from the artificial intelligence model being greater than or equal to a threshold value, identify an attack of an abnormal message.

A method for detecting an attack of an abnormal message according to an example embodiment may include: based on a first message for an authentication request being received, identifying information included in the first message. According to an embodiment, the method may include an operation of acquiring at least one of a first feature acquired using information related to the authentication request among information included in the first message, a second feature acquired using information related to a device and a telephone number among information included in a plurality of first messages received during a designated time period, or a third feature acquired using information related to a device and a telephone number among information included in a plurality of first messages received from a designated country during a designated time period. According to an embodiment, the method may include an operation of inputting the at least one feature to an artificial intelligence model as an input value. According to an embodiment, the method may include an operation of based on an output value output from the artificial intelligence model being greater than or equal to a threshold value, identifying an attack of an abnormal message.

An example embodiment may provide a non-transitory recording medium computer-readable storing instructions which, when executed by an server, cause the server to perform at least one operation, wherein the at least one operation may include an operation of based on a first message for an authentication request being received, identifying information included in the first message. According to an embodiment, the at least one operation may include an operation of acquiring at least one of a first feature acquired using information related to the authentication request among information included in the first message, a second feature acquired using information related to a device and a telephone number among information included in a plurality of first messages received during a designated time period, or a third feature acquired using information related to a device and a telephone number among information included in a plurality of first messages received from a designated country during a designated time period. According to an embodiment, the at least one operation may include an operation of inputting the at least one feature to an artificial intelligence model as an input value. According to an embodiment, the at least one operation may include an operation of based on an output value output from the artificial intelligence model being greater than or equal to a threshold value, identifying an attack of an abnormal message.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of a server according to various embodiments; and

FIG. 2 is a flowchart illustrating an example operation of detecting an attack of an abnormal message in a server according to various embodiments.

### DETAILED DESCRIPTION

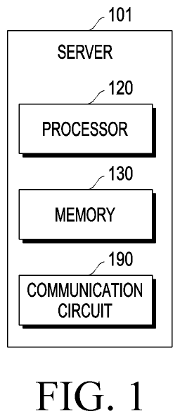

FIG. 1 is a block diagram illustrating an example configuration of a server according to various embodiments.

Referring to FIG. 1, the server 101 may include a processor (e.g., including processing circuitry) 120, memory 130, and a communication circuit 190.

According to an embodiment, the processor 120 may include various processing circuitry and perform general control operations for the server 101. According to an embodiment, the processor 120 may execute software to control at least one other component (e.g., a hardware or software component) of the server 101 connected to the processor 120 and perform data processing or calculations based on instructions. The instructions according to an embodiment may include an instruction configured by a machine language processable by the server 101 or the processor 120. For example, the instructions may include an instruction corresponding to an operation instruction used in a program. Each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

According to an embodiment, the processor 120, in case that a first message (e.g., an SMS) requesting authentication is received, may acquire (calculate) at least one feature for detecting an attack of an abnormal message, based on information included in the first image.

According to an embodiment, the first message may include basic authentication request information, such as user identifier information, an e-mail of a user account, information about a target phone number, information about the time of the authentication request through the first message, Internet Protocol (IP) address information, device identifier information (such as a unique International Mobile Equipment Identity (IMEI) number), device model information, client and OS version information, information about a type of authentication service (such as account sign-in or two-factor authentication configuration), information about an application or service being used, information about a country from which the first message (e.g., an SMS) was sent, a type of operation (e.g., request transmission or successful verification), and billing charge information for the first message.

According to an embodiment, the first message may include information about a client type used to initially register for an account, information about whether a specific user has previously registered “trusted devices” (e.g., excluding two-factor authentication operations through the first message), and information about whether ownership of a specific phone number has been previously verified. The “trusted devices” may refer, for example, to a device (e.g., at least one of a smartphone, tablet, or PC) that is registered to be accessed only by the user, and when logging in using the trusted device, the user may quickly log in by simply entering a username and password, without the need for two-factor authentication through an SMS (e.g., two-factor authentication).

According to an embodiment, the processor 120 may acquire at least one of a first feature acquired (calculated) using information related to the authentication request among information included in the first message, a second feature acquired (calculated) using information related to a device and a telephone number among information included in a plurality of first messages received during a designated time period (e.g., 24 hours), and a third feature acquired (calculated) using information related to a device and a telephone number among information included in a plurality of first messages received from a designated country during a designated time period (e.g., 24 hours).

According to an embodiment, the processor 120 may acquire (calculate) the first feature (e.g., a single-event feature) using information related to the authentication request among information included in a single first message.

According to an embodiment, the processor 120 may acquire (calculate) the first feature using billing charge information of the first message or information on whether a disposable e-mail is used among information included in the first message (e.g., an SMS).

According to an embodiment, the processor 120 may acquire (calculate) the first feature using, among information included in the first message (e.g., an SMS), at least one of billing charge information of the first message, information about a device registered to a user's account at a time point of requesting authentication through the first message, information about a difference between a time point of requesting authentication through the first message and a time point when a domain for an email was generated, or information about a difference between a time point of requesting authentication through the first message and a time point when a device that sent the first message was released.

According to an embodiment, the processor 120 may acquire the first feature by calculating information included in the first message as shown in <Table 1> and <Table 2>.

<Table 1> below illustrates an example calculation method for acquiring the first feature from the first message sent through the Web, and <Table 2> below illustrates an example calculation method for acquiring the first feature from the first message sent through a device.

According to an embodiment, the processor 120 may acquire the first feature through <Table 1> and <Table 2> below.

TABLE 1

| Type of | |
|---|---|
| first feature | Calculation method for acquiring first feature |
| sms_cost | Retrieve per-SMS billing charges for SMS destination |
| | country |
| have_trust_dvce | Identify whether at least one trusted device has been |
| | registered to user account at time point when SMS |
| | request is performed |
| domain_sms_td | SMS request date - date when email domain first |
| | appeared |
| jn_sms_td | SMS request date - generation data of user account |
| is_same_cnty | Country code of user account identical to that of |
| | SMS request |
| service_id | Type of SMS request-related service |
| join_channel | Web or mobile channel used for initial registration |
| | (signup) |

In <Table 1> above, “ss_cost” indicates a billing charge for each country for sending a single SMS, “have_trust_dvce” indicates identifying whether at least one trusted device is registered to the user account, “domain_sns_td” indicates a time difference between a date of the authentication request through an SMS and a date when an (in-use) email domain first appeared in an SMS history database in the memory 130, and “jn_sms_td” indicates a time difference between a date of authentication request through an SMS and a date when the user initially generated the account.

In <Table 1> above, “is_same_cnty” indicates identifying whether a country code of the user account is identical to that of the SMS request, “service id” indicates a type or SMS request-related service, and “join channel” indicates a Web or mobile channel used for initial registration (signup).

TABLE 2

| Type of | |
|---|---|
| first feature | Calculation method for acquiring first feature |
| sms_cost | Retrieve per-SMS billing charge rate for each SMS |
| | destination country |
| dvce_age | SMS request date - device initial release date |
| | (converted to monthly basis) |
| dvce_user_cnt | Calculate number of unique user IDs related to |
| | specific IMEI |
| ph_reg_sms_td | SMS request date - date when target phone number |
| | is first registered |
| ph_reg_user_cnt | Calculate number of unique user IDs related to |
| | specific phone number |
| osver_sms_td | SMS request date - date when OS version is first |
| | released |
| clver_sms_td | SMS request date - date when application client |
| | version is first released |
| is_ph_vrf | Identify whether successful phone number |
| | authentication count is greater than 0 |
| os_td | Release data of OS version used - release date |
| | of latest OS version available in corresponding |
| | device model |
| dvce_vld_sms_td | SMS request date - last value of successful |
| | verification date on specific device model and |
| | OS version |
| is_same_cnty | Identify whether IP country is identical to SMS |
| | country |

In <Table 2> above, “sms_cost” may indicate the billing rate for each country for sending a single SMS, “dvce_age” may indicate a time difference between a date of the authentication request through an SMS and a device's initial release date, “dvce_user_cnt” may indicate the number of user IDs related to a specific device IMEI, and “ph_reg_sms_td” may indicate a time difference between a date of the authentication request through an SMS and a date when a target phone number is first registered.

In <Table 2> above, “ph_reg_user_cnt” may indicate the number of user IDs related to a specific phone number, “osver_sms_td” may indicate a time difference between a date of the authentication request through an SMS and a date when an OS version (used to submit the request) is first released, and “clver_sms_td” may indicate a time difference between a date of the authentication request through an SMS and a date when an application client version (used to submit the request) is first released.

In <Table 2> above, “is_ph_vrf” may indicate identifying whether a target phone number has been previously authenticated, “os_td” may indicate a time difference between a date when an OS version used in the SMS authentication request is released and a date when a latest OS version available for an identical device model is released, “dvce_vld_sms_td” may indicate a time difference between a date of the authentication request through an SMS and a date of a last successful verification completed by an identical device model (used in a current request) and OS version, and “is_same_cnty” may indicate identifying whether an IP country and an SMS destination country are identical to each other.

According to an embodiment, the processor 120 may acquire (calculate) the second feature (e.g., a multi-event feature) using information related to a device and a phone number among information included in a plurality of first messages continuously received during a designated time period (e.g., 24 hours).

According to an embodiment, the processor 120 may detect a plurality of first messages continuously received during a designated time period (e.g., 24 hours) before a time point when a current first message is received among a plurality of first messages (e.g., SMSs) stored in an SMS record data base of the memory 130.

According to an embodiment, the processor 120 may acquire (calculate) the second feature using at least one of information about the number of unique IPs related to a specific phone number, information about a sum of billing charges for first messages with respect to a specific phone number, information about the number of unique IPs related to a specific IMEI, information about the number of unique phone numbers related to a specific IMEI, or information about a sum of billing charges for first messages with respect to a specific IMI among information included in the a plurality of first messages (e.g., SMSs).

According to an embodiment, the processor 120 may acquire the second feature by calculating information included in the first message as shown in <Table 3> and <Table 4>.

<Table 3> below illustrates an example calculation method for acquiring the second feature from the first message sent through the Web, and <Table 4> below illustrates an example calculation method for acquiring the second feature from the first message sent through a device.

According to an embodiment, the processor 120 may acquire the second feature through <Table 3> and <Table 4> below.

TABLE 3

| Type of | |
|---|---|
| second feature | Calculation method for acquiring second feature |
| user_ip_cnt | Number of unique IPs related to specific user |
| user_ph_cnt | Number of unique phone numbers related to specific |
| | user |
| user_cost | Sum of all SMS billing charges of specific user |
| user_conv | Number of successful SMS authentications (with |
| | respect to specific user)/number of SMS requests |
| | (with respect to specific user) |
| user_sms | Number of SMSs sent by user |
| user_td_med | MED (all time difference values of two consecutive |
| | SMS requests measured with respect to specific user) |
| user_td_avg | MEAN (all time difference values of two consecutive |
| | SMS requests measured with respect to specific user) |
| user_td_std | STDEV (all time difference values of two consecutive |
| | SMS requests measured with respect to specific user) |
| ph_ip_cnt | Number of unique IPs related to specific phone number |
| ph_user_cnt | Number of unique user IDs related to specific phone |
| | number |
| ph_cost | Sum of all SMS billing charges for specific phone |
| | number |
| ph_conv | Number of successful SMS authentications (with |
| | respect to specific phone number)/number of SMS |
| | requests (with respect to specific phone number) |
| ph_sms | Number of SMSs sent to specific phone number |
| ph_td_med | MED (all time difference values of two consecutive |
| | SMS requests measured with respect to specific |
| | phone number) |
| ph_td_avg | MEAN (all time difference values of two consecutive |
| | SMS requests measured with respect to specific phone |
| | number) |

In <Table 3> above, “user_ip_cnt” may indicate the number of unique IPs related to a specific user, “user_ph_cnt” may indicate the number of unique phone numbers related to a specific user, and “user_cost” may indicate a sum of all SMS billing charges for a specific user.

In <Table 3> above, “user_conv” may indicate a conversion rate (SMS verification success rate) measured with respect to a specific user, “user_sms” may indicate the number of SMS sent by a user, “user_td_med” may indicate a median time difference value among all time difference values calculated for a specific user, where each time difference value is calculated between dates and times of authentication requests through two consecutive SMS, and “user_td_avg” may indicate an average time difference value among all time difference values calculated for a specific user.

In <Table 3> above, “user_td_std” may indicate a standard deviation of all time difference values calculated with respect to a specific user, “ph_ip_cnt” may indicate the number of unique IPs related to a specific phone number, “ph_user_cnt” may indicate the number of unique user IDs related to a specific phone number, and “ph_cost” may indicate a sum of all SMS billing charges with respect to a specific phone number.

In <Table 3> above, “ph_conv” may indicate a conversion rate (SMS verification success rate) measured with respect to a specific phone number, “ph_sms” may indicate the number of SMSs sent to a specific phone number, “ph_td_med” may indicate a median time difference value among all time difference values calculated for a specific phone number, where each time difference value is calculated between dates and times of authentication requests through two consecutive SMSs, and “ph_td_avg” may indicate a standard deviation of all time difference values calculated for a specific phone number.

TABLE 4

| Type of | |
|---|---|
| second feature | Calculation method for acquiring second feature |
| imei_ip_cnt | Number of unique IPs related to specific IMEI |
| imei_ph_cnt | Number of unique phone numbers related to |
| | specific IMEI |
| ip_imei_cnt | Number of unique IMEI related to specific IP |
| | addresses |
| ph_xmodel_cnt | First, connect device model and OS version into |
| | a single string, and count number of unique |
| | connection strings related to specific phone |
| | number |
| imei_xmodel_cnt | First, connect device model and OS version into |
| | a single string, and count number of unique |
| | connection strings related to specific IMEI |
| imei_cost | Sum of all SMS billing charges for specific |
| | IMEI |
| ph_cost | Sum of all SMS billing charges for specific |
| | phone number |
| imei_sms | Number of SMS requests sent by specific IMEI |
| ph_sms | Number of SMS requests sent by specific phone |
| | number |
| imei_conv | Number of successful SMS authentications with |
| | respect to specific IMEI/number of SMS requests |
| ph_conv | Number of successful SMS authentications with |
| | respect to specific phone number/number of SMS |
| | requests |
| ph_ph_vrf_cnt | Count number of successful verification operations |
| | for specific phone number |
| imei_max_vld_cnt | Connect all operations for specific IMEI and service |
| | type, and find longest consecutive occurrence of |
| | successful verification |
| ph_max_vld_cnt | Connect all operations for specific phone number |
| | and service type, and find longest consecutive |
| | occurrence of successful verification |
| ip_sms | Number of SMS requests sent through specific IP |
| | address |
| imei_td_avg | Time difference value measured from all |
| | consecutive SMS requests with respect to specific |
| | IMEI |

In <Table 4> above, “imei_ip_cnt” may indicate the number of unique IPs related to a specific IMEI, “imei_ph_cnt” may indicate the number of unique phone numbers related to a specific IMEI, and “ip_imei_cnt” may indicate the number of unique IMEIs related to a specific IP address.

In <Table 4> above, “ph_xmodel_cnt” may indicates the number of combinations of unique device models and OS versions related to a specific phone number, “imei_xmodel_cnt” may indicate the number of combinations of unique device models and OS versions related to a specific IMEI, “imei_cost” may indicate a sum of all SMS billing charges for a specific IMEI, “ph_cost” may indicate a sum of all SMS billing charges for a specific phone number, “imei_sms” may indicate the number of SMS requests sent by a specific IMEI, “ph_sms” may indicate the number of SMS requests sent by a specific phone number, “imei_cony” may indicate a conversion rate (SMS verification success rate) for a specific IMEI, and “ph_cony” may indicate a conversion rate (SMS verification success rate) for a specific phone number.

In <Table 4> above, “ph_pph_vrf_cnt” may indicate the number of times a specific phone number has been successfully verified, “imei_max_vld_cnt” may indicate the maximum number of authentication requests through an SMS that a specific IMEI has consecutively verified for an identical service type, and “ph_max_vld_cnt” may indicate the maximum number of SMS requests that a specific phone number has consecutively verified for an identical service type.

In <Table 4> above, “ip_sms” may indicate the number of SMS requests sent through a specific IP address, and “imei_td_avg” may indicate an average time difference value for all time difference values calculated for a specific IMEI.

According to an embodiment, the processor 120 may acquire (calculate) the third feature (e.g., a country-event feature) using information related to a device and a phone number among information included in a plurality of first messages continuously sent from a designated country (region) during a designated time period (e.g., 25 hours).

According to an embodiment, the processor 120 may acquire (calculate) the third feature using at least one of information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, or information about the number of IMEIs having an identical prefix in a designated country, among information included in the a plurality of first messages (e.g., SMSs).

According to an embodiment, the processor 120 may designate the number of prefixes of a phone number.

According to an embodiment, the processor 120 may acquire the third feature by calculating information included in the first message as shown in <Table 5> and <Table 6>.

<Table 5> below illustrates an example calculation method for acquiring the third feature from the first message sent through the Web, and <Table 6> below illustrates an example calculation method for acquiring the third feature from the first message sent through a device.

According to an embodiment, the processor 120 may acquire the second feature through <Table 5> and <Table 6> below.

TABLE 5

| Type of | |
|---|---|
| third feature | Calculation method for acquiring third feature |
| domain_prop_inc | Rate of specific email domains used for 24- |
| | hour period in specific country - trimmed |
| | average daily rate of specific email domains |
| | used |
| app_prop_inc | Rate of specific application or service used |
| | for 24-hour period in specific country - trimmed |
| | average daily rate of specific application/service |
| | used |
| gmail_prop_dec | Rate of SMS requests sent through specific emails |
| | (e.g., gmail) in general traffic - rate of SMS |
| | requests sent through specific email (e.g., gmail) |
| tld_prop_inc | Rate of SMS request sent by top-level representation |
| | of specific email domain - rate of SMS request sent |
| | by top-level representation of specific domain in |
| | general traffic |
| ph_prefix_cnt | Detect prefix of phone number and count unique |
| | number of phone number including identical prefix |
| | within specific country |

In <Table 5> above, “domain_prop_inc” may indicate a rate change of a specific email domain used (extracted from a current SMS request) for 24 hours compared to an average value trimmed for a specific country, and “app_prop_inc” may indicate a rate change of a specific application and/or service used (extracted from a current SMS request) for 24 hours compared to an average value trimmed for a specific country.

In <Table 5> above, “gmail_prop_dec” may indicate a decrease in a rate of an SMS request sent through a specific email (e.g., Gmail) compared to a pre-calculated reference rate in general traffic (the rate is calculated based on the last 24 hours of SMS traffic volume in a corresponding country), “tld_prop_inc” may indicate an increase in a rate of an SMS request sent by a top-level domain representation of a specific email (e.g., .com) compared to a pre-calculated reference rate in general traffic (the rate is calculated based on SMS traffic for last 24 hours in a given country), and “ph_prefix_cnt” may indicate a count of the number of specific phone numbers including a prefix of the identical phone number (extracted from a current SMS request) within the identical country for the last 24 hours.

TABLE 6

| Type of | |
|---|---|
| third feature | Calculation method for acquiring third feature |
| peak_label | Determines whether amount of traffic generated |
| | within 24 hours from a specific country is |
| | significantly greater than [average and/or |
| | median daily traffic], and whether conversion |
| | rate is significantly less than [average/median |
| | daily conversion rate] |
| ph_prefix_cnt | Detect prefix of phone number and calculate |
| | number of unique phone numbers having |
| | identical prefix in specific country |
| imei_prefix_sms | Detect prefix of IMEI and calculate number of |
| | occurrences of same prefix within identical |
| | country and identical device model |
| imei_prefix_cnt | Detect prefix of IMEI and calculate number |
| | of unique IMEIs having same prefix within |
| | identical country and identical device model |
| xmodel_sms_dist | Number of SMS requests submitted by specific |
| | device model or total number of SMS requests |
| | in specific country |
| ph_sim | String similarity between phone number of |
| | previous request and phone number of current |
| | request selected based on identical country |
| | and device model is measured |
| imei_sim | String similarity between IMEI of previous |
| | request and IMEI of current request selected |
| | based on identical country and device model |
| | is measured |
| ph_prefix_sms_prop | Extract prefix of phone number and calculate |
| | [number of occurrences of prefix within |
| | specific country/total number of SMS requests |
| | for specific country] |
| ph_prefix_conv | Number of successful SMS authentications |
| | (with respect to prefix of specific phone |
| | number)/number of SMS requests (with respect |
| | to prefix of specific phone number) |
| imei_prefix_sms_prop | Extract prefix of IMEI and calculate [number |
| | of occurrences of prefix within specific country |
| | and device model/total number of SMS |
| | requests for specific country] |
| imei_prefix_conv | Number of successful SMS verifications (with |
| | respect to specific IMEI prefix)/number of |
| | SMS requests (with respect to specific IMEI); |
| | when IMEI is empty, fill IMEI prefix with |
| | empty value and calculate prefix of IMEI |
| | having no feature (imei_prefix_conv) above |
| xmodel_conv | Number of successful SMS authentications |
| | (with respect to specific device model)/number |
| | of SMS requests (with respect to specific |
| | device model) |

In <Table 6> above, “peak_label” may indicate that an authentication request through an SMS is sent during a peak traffic time period (clearly visible in a destination country), “ph_prefix_cnt” may indicate a calculation of the number of unique phone numbers having an identical phone number prefix (extracted from a current SMS request) within an identical country, “imei_prefix_sms” may indicate a calculation of the number of SMS requests sent using an identical IMEI's prefix (extracted from a current SMS request) within the same country, and “imei_prefix_cnt” may indicate a calculation of the number of unique IMEIs having an identical IMEI's prefix (extracted from a current SMS request) within an identical country.

In <Table 6> above, “xmodel_sms_dist” may indicate a rate of authentication requests through an SMS submitted by a specific device model (extracted from a current SMS request) in the total amount of SMS traffic in a specific country, “ph_sim” may indicate a similarity distance for a string measured between a phone number used in a current authentication request through an SMS and a phone number in a previous request, where the previous request may be selected based on a country code and device model, and “imei_sim” may indicate a string similarity distance measured between an IMEI used in a current authentication request through an SMS and an IMEI from a previous request, where the previous request may be selected based on a country code and device model.

In <Table 6> above, “ph_prefix_sms_prop” may indicate a rate of SMS requests sent with a prefix of an identical phone number (extracted from a current SMS request) within an identical country during the last 24 hours, “ph_prefix_conv” may indicate a rate of conversion (SMS identification success rate) measured for a prefix of an identical phone number (extracted from a current SMS request) within an identical country during the last 24 hours, “imei_prefix_sms_prop” may indicate a rate of SMS requests sent with a prefix of an identical IMEI (extracted from a current SMS request) within an identical country and device model during the last 24 hours, “imei_prefix_conv” may indicate a conversion rate (SMS identification success rate) measured for a prefix of an identical IMEI (extracted from a current SMS request) within an identical country and device model during the last 24 hours, and “xmodel_conv” may indicate a conversion rate (SMS identification success rate) measured for a specific device model (extracted from the current SMS request) within an identical country for the last 24 hours.

According to an embodiment, the processor 120 may input at least one of the first feature (e.g., a single-event feature), the second feature (e.g., a multi-event feature), and the third feature (e.g., a country-event feature) as an input value for the artificial intelligence model.

According to an embodiment, the processor 120 may acquire the at least one feature as a designated number of numerical values used to train the artificial intelligence model, arrange the numerical values in the order used for training the artificial intelligence model, and then input an input of the artificial intelligence model as a value.

According to an embodiment, the processor 120, in case that an output value (e.g., a value between 1 and 0) is received from the artificial intelligence model, may compare a score (e.g., a value between 1 and 0) corresponding to the output value with a threshold value (e.g., 0.5), in case that the comparison result output value is greater than or equal to a threshold value, identify an attack of an abnormal message, and reject the authentication request.

According to an embodiment, the processor 120 may pre-train the artificial intelligence model to detect an attack of an abnormal message based on at least one of the first feature, the second feature, or the third feature.

According to an embodiment, the processor 120 may label a first time point at which an excessive number of first messages requesting authentication are received as an attack point of an abnormal message, based on a peak traffic detection rule that may be designated arbitrarily to detect an attack period of an abnormal message and a labeling rule that may be designated arbitrarily to label an attack of an abnormal message, and label a second time point excluding the first time point as a reception of a normal message.

According to an embodiment, the processor 120 may detect at least one of the first feature, the second feature, or the third feature from information included in the abnormal message received at the first time point and train the artificial intelligence model using the detected at least one feature.

According to an embodiment, the processor 120 may detect at least one of the first feature, the second feature, or the third feature from information included in the normal message received at the second time point and train the artificial intelligence model using the detected at least one feature.

According to an embodiment, the memory 130 may store a plurality of artificial intelligence models.

According to an embodiment, each of the a plurality of artificial intelligence models may correspond to a model having been trained based on a designated kind of learning algorithm and may correspond to an artificial intelligence model implemented to receive various types of data (or content), perform calculations, and output (or acquire) result data. According to an embodiment, the a plurality of artificial intelligence models may include a generative artificial intelligence model. For example, a plurality of artificial intelligence models (e.g., machine learning models and deep learning models) may be generated by performing training to output specific kinds of result data as output data by receiving specified kinds of data as input data based on a machine learning algorithm or a deep learning algorithm in the server 101, and thus the artificial intelligence models stored in the server 101 or having been trained from an external electronic device may be transferred to and stored in the server 101. For example, the server 101 may output input data as output data of a model trained through designated kinds of artificial intelligence based on a machine learning algorithm or a deep learning algorithm. The machine learning algorithms may include supervised algorithms, such as linear regression and logistic regression, unsupervised algorithms, such as clustering, visualization and dimensionality reduction, and association rule learning, and reinforcement algorithms, wherein the deep learning algorithms may include artificial neural networks (ANNs), deep neural networks (DNNs), convolutional neural networks (CNNs), and may further include various other learning algorithms without limitation as described herein. The training-completed artificial intelligence model may be implemented to include a plurality of calculation operations (e.g., a convolutional layer, or pooling layer) for calculating input data and output result data by performing calculation for input data based on the a plurality of calculations operations.

The communication circuit 190 according to an embodiment may establish communication connection with an external electronic device (e.g., another electronic device or server) and transmit and/or receive data using various types of communication methods.

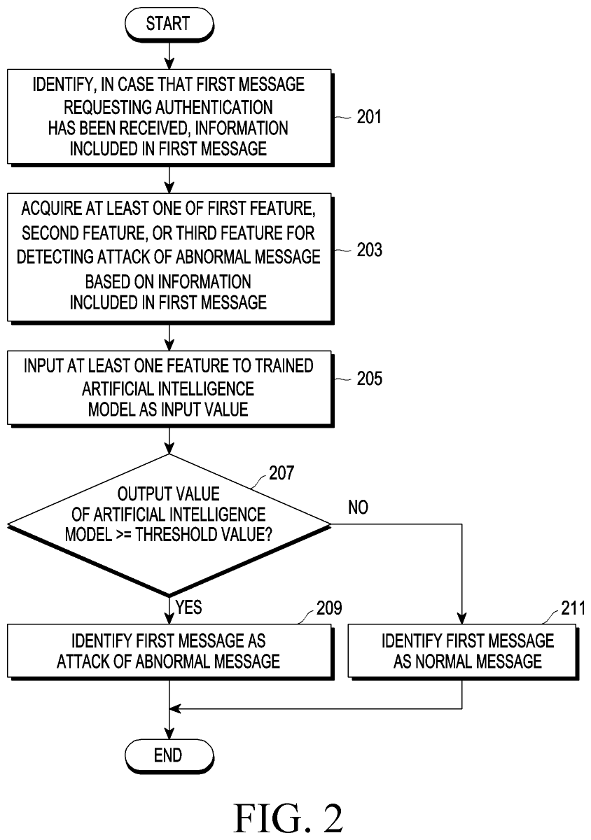

According to an example embodiment, a server (e.g., the server 101 in FIG. 1) may include at least one processor (e.g., the processor 120 in FIG. 2), comprising processing circuitry, and memory (e.g., the memory 130 in FIG. 2) storing instructions that, when executed by the at least one processor individually or collectively, may cause the server to receive a first message for an authentication request and identify information included in the first message. According to an embodiment, the instructions, when executed by the at least one processor individually or collectively, may cause the server to acquire at least one of a first feature acquired using information related to the authentication request among information included in the first message, a second feature acquired using information related to a device and a telephone number among information included in a plurality of first messages received during a designated time period, or a third feature acquired using information related to a device and a telephone number among information included in a plurality of first messages received from a designated country during a designated time period. According to an embodiment, the instructions, when executed by the at least one processor individually or collectively, may cause the server to input the at least one feature to an artificial intelligence model as an input value. According to an embodiment, the instructions, when executed by the at least one processor individually or collectively, may cause the server to, based on an output value output from the artificial intelligence model being greater than or equal to a threshold value, identify an attack of an abnormal message.

According to an example embodiment, the first feature may include a feature acquired using information related to an authentication request included in a single first message.

According to an example embodiment, the information related to the authentication request used to acquire the first feature may include at least one of a billing charge of the first message, information about a device registered to a user's account at a time point of requesting authentication through the first message, information about a difference between a time point of requesting authentication through the first message and a time point at which a domain for an email was generated, or information about a difference between a time point of requesting authentication through the first message and a time point at which a device that sent the first message was released.

According to an example embodiment, the second feature may represent a feature acquired using information related to a device and a phone number among information included in the plurality of first messages continuously received during a designated time period.

According to an example embodiment, the information related to the device and the phone number used for acquiring the second feature may include at least one of information about the number of unique IPs related to a specific phone number, information about a sum of billing charges for first messages with respect to a specific phone number, information about the number of unique IPs related to a specific IMEI, information about the number of unique phone numbers related to a specific IMEI, or information about a sum of billing charges for first messages with respect to a specific IMEI.

According to an example embodiment, the third feature may represent a feature acquired using information related to the device and the phone number among information included in the plurality of first messages sent from a designated country during a designated time period.

According to an example embodiment, the information related to the device and the phone number used for acquiring the third feature may include at least one of information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, or information about the number of IMEIs having an identical prefix in a designated country.

According to an example embodiment, the instructions, when executed by the at least one processor individually or collectively, may cause the server to: acquire a numerical value corresponding to the at least one feature and input the acquired numerical value to an artificial intelligence model as an input value.

According to an example embodiment, the instructions, when executed by the at least one processor individually or collectively, may cause the server to arrange the at least one feature in the order used for training the artificial intelligence model, and input the arranged at least one feature to the artificial intelligence model as an input value.

According to an example embodiment, the artificial intelligence model may be trained to detect an attack of an abnormal message based on at least one of the first feature, the second feature, or the third feature.

FIG. 2 is a flowchart illustrating an example operation of detecting an attack of an abnormal message in a server according to various embodiments. The operation of detecting an attack of an abnormal message may include operations 201 to 211. In the following example embodiment, respective operations may be sequentially performed, but are not necessarily sequentially performed. For example, the sequential position of each operation may be changed, at least two operations may be performed in parallel, or another operation may be added.

In operation 201, a server (e.g., the server 101 in FIG. 1 and/or the processor 120 in FIG. 1), in case that a first message requesting authentication is received, may identify information included in the first message.

According to an embodiment, the first message may include basic authentication request information, such as user identifier information, an e-mail of a user account, information about a target phone number, information about the time of the authentication request through the first message, Internet Protocol (IP) address information, device identifier information (such as a unique International Mobile Equipment Identity (IMEI) number), device model information, client and OS version information, information about a type of authentication service (such as account sign-in or two-factor authentication configuration), information about an application or service being used, information about a country from which the first message (e.g., an SMS) was sent, a type of operation (e.g., request transmission or successful verification), and billing charge information for the first message.

According to an embodiment, the first message may include information about a client type used to initially register for an account, information about whether a specific user has previously registered “trusted devices” (e.g., excluding two-factor authentication operations through the first message), and information about whether ownership of a specific phone number has been previously verified.

In operation 203, the server (e.g., the server 101 in FIG. 1 and/or the processor 120 in FIG. 1) may acquire (calculate) at least one feature among the first feature, the second feature, or the third feature for detecting an attack of an abnormal message based on the information included in the first message.

According to an embodiment, the server may acquire at least one of a first feature acquired (calculated) using information related to the authentication request among information included in the first message, a second feature acquired (calculated) using information related to a device and a telephone number among information included in a plurality of first messages received during a designated time period (e.g., 24 hours), and a third feature acquired (calculated) using information related to a device and a telephone number among information included in a plurality of first messages received from a designated country during a designated time period (e.g., 24 hours).

According to an embodiment, the server may acquire (calculate) the first feature (e.g., a single-event feature) using information related to the authentication request among information included in a single first message.

According to an embodiment, the server may acquire (calculate) the first feature using billing charge information of the first message or information on whether a disposable e-mail is used among information included in the first message (e.g., an SMS).

According to an embodiment, the server may acquire (calculate) the first feature using, among information included in the first message (e.g., an SMS), at least one of billing charge information of the first message, information about a device registered to a user's account at a time point of requesting authentication through the first message, information about a difference between a time point of requesting authentication through the first message and a time point when a domain for an email was generated, or information about a difference between a time point of requesting authentication through the first message and a time point when a device that sent the first message was released.

According to an embodiment, the server may acquire the first feature by calculating information included in the first message as shown in <Table 1> and <Table 2> above.

According to an embodiment, the server may acquire (calculate) the second feature (e.g., a multi-event feature) using information related to a device and a phone number among information included in a plurality of first messages continuously received during a designated time period (e.g., 24 hours).

According to an embodiment, the server may detect a plurality of first messages continuously received during a designated time period (e.g., 24 hours) before a time point when a current first message is received among a plurality of first messages (e.g., SMSs) stored in an SMS record data base of the memory (e.g., the memory 130 in FIG. 1).

According to an embodiment, the server may acquire (calculate) the second feature using at least one of information about the number of unique IPs related to a specific phone number, information about a sum of billing charges for first messages with respect to a specific phone number, information about the number of unique IPs related to a specific IMEI, information about the number of unique phone numbers related to a specific IMEI, or information about a sum of billing charges for first messages with respect to a specific IMEI among information included in the a plurality of first messages (e.g., SMSs).

According to an embodiment, the server may acquire the second feature by calculating information included in the first message as shown in <Table 3> and <Table 4> above.

According to an embodiment, the server may acquire (calculate) the third feature (e.g., a country-event feature) using information related to a device and a phone number among information included in a plurality of first messages continuously sent from a designated country (region) during a designated time period (e.g., 25 hours).

According to an embodiment, the server may acquire (calculate) the third feature using at least one of information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, or information about the number of IMEIs having an identical prefix in a designated country, among information included in the a plurality of first messages (e.g., SMSs).

According to an embodiment, the server may acquire the third feature by calculating information included in the first message as shown in <Table 5> and <Table 6> above.

In operation 205, the server (e.g., the server 101 in FIG. 1 and/or the processor 120 in FIG. 1) may input the at least one feature as an input value to a trained artificial intelligence model.

According to an embodiment, the server may input at least one of the first feature (e.g., a single-event feature), the second feature (e.g., a multi-event feature), and the third feature (e.g., a country-event feature) as an input value for the artificial intelligence model.

According to an embodiment, the server may acquire the at least one feature as a designated number of numerical values used to train the artificial intelligence model, arrange the numerical values in the order used for training the artificial intelligence model, and then input an input of the artificial intelligence model as a value.

According to an embodiment, the server may pre-train the artificial intelligence model to detect an attack of an abnormal message based on at least one of the first feature, the second feature, or the third feature.

In operation 207, the server (e.g., the server 101 in FIG. 1 and/or the processor 120 in FIG. 1) may compare an output value of the artificial intelligence model with a threshold value.

In operation 207, the server (e.g., the server 101 in FIG. 1 and/or the processor 120 in FIG. 1), in case that the output value of the artificial intelligence model is greater than or equal to the threshold value in operation 207, may identify an attack of an abnormal message in operation 209.

According to an embodiment, the server, in case that an output value is received from the artificial intelligence model, may compare a score (e.g., a value between 1 and 0) corresponding to the output value with a threshold value (e.g., 0.5), in case that the comparison result output value is greater than or equal to the threshold value, identify an attack of an abnormal message, and reject the authentication request.

In operation 207, the server (e.g., the server 101 in FIG. 1 and/or the processor 120 in FIG. 1), in case that the output value of the artificial intelligence model is less than or equal to the threshold value, may identify that it is a normal message in operation 211.

According to an embodiment, the server, in case that an output value is received from the artificial intelligence model, may compare a score (e.g., a value between 1 and 0) corresponding to the output value with a threshold value (e.g., 0.5), in case that the comparison result output value is less than or equal to the threshold value, identify that it is a normal message, and perform an authentication operation.

According to an example embodiment, a method for detecting an attack of an abnormal message may include: an operation of based on a first message for an authentication request being received, identifying information included in the first message. According to an embodiment, the method may include an operation of acquiring at least one of a first feature acquired using information related to the authentication request among information included in the first message, a second feature acquired using information related to a device and a telephone number among information included in a plurality of first messages received during a designated time period, or a third feature acquired using information related to a device and a telephone number among information included in a plurality of first messages received from a designated country during a designated time period. According to an embodiment, the method may include an operation of inputting the at least one feature to an artificial intelligence model as an input value. According to an embodiment, the method may include an operation of based on an output value output from the artificial intelligence model being greater than or equal to a threshold value, identifying an attack of an abnormal message.

According to an example embodiment, in the method, the first feature may include a feature acquired using information related to an authentication request included in a single first message.

According to an example embodiment, in the method, the information related to the authentication request used to acquire the first feature may include at least one of a billing charge of the first message, information about a device registered to a user's account at a time point of requesting authentication through the first message, information about a difference between a time point of requesting authentication through the first message and a time point at which a domain for an email was generated, or information about a difference between a time point of requesting authentication through the first message and a time point at which a device that sent the first message was released.

According to an example embodiment, in the method, the second feature may represent a feature acquired using information related to a device and a phone number among information included in the plurality of first messages continuously received during a designated time period.

According to an example embodiment, in the method, the information related to the device and the phone number used for acquiring the second feature may include at least one of information about the number of unique IPs related to a specific phone number, information about a sum of billing charges for first messages with respect to a specific phone number, information about the number of unique IPs related to a specific IMEI, information about the number of unique phone numbers related to a specific IMEI, or information about a sum of billing charges for first messages with respect to a specific IMEI.

According to an example embodiment, in the method, the third feature may represent a feature acquired using information related to the device and the phone number among information included in the plurality of first messages sent from a designated country during a designated time period.

According to an example embodiment, in the method, the information related to the device and the phone number used for acquiring the third feature may include at least one of information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, or information about the number of IMEIs having an identical prefix in a designated country.

According to an example embodiment, the method may further include: acquiring a numerical value corresponding to the at least one feature and inputting the acquired numerical value to an artificial intelligence model as an input value.

According to an example embodiment, the method may further include: arranging the at least one feature in the order used for training the artificial intelligence model, and inputting the arranged at least one feature to the artificial intelligence model as an input value.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with an embodiment of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A server comprising:
at least one processor, comprising processing circuitry; and
memory storing instructions that, when executed by the at least one processor individually or collectively, cause the server to:
receive a first message for an authentication request and identify information included in the first message;
acquire at least one of a first feature acquired using information related to the authentication request among information included in the first message, a second feature acquired using information related to a device and a telephone number among information included in a plurality of first messages received during a designated time period, and/or a third feature acquired using information related to a device and a telephone number among information included in a plurality of first messages received from a designated country during a designated time period;
input the at least one feature to an artificial intelligence model as an input value; and
based on an output value output from the artificial intelligence model being greater than or equal to a threshold value, identify the first message as an attack of an abnormal message.

2. The server of claim 1, wherein the first feature includes a feature acquired using information related to the authentication request included in a single first message.

3. The server of claim 1, wherein the information related to the authentication request, used to acquire the first feature, comprises at least one of: a billing charge of the first message, information about a device registered to a user's account at a time point of requesting authentication through the first message, information about a difference between a time point of requesting authentication through the first message and a time point at which a domain for an email was generated, and/or information about a difference between a time point of requesting authentication through the first message and a time point at which a device that sent the first message was released.

4. The server of claim 1, wherein the second feature includes a feature acquired using information related to a device and a phone number among information included in the plurality of first messages continuously received during a designated time period.

5. The server of claim 1, wherein the information related to the device and the phone number, used to acquire the second feature, comprises at least one of: information about the number of unique IPs related to a specific phone number, information about a sum of billing charges for first messages with respect to a specific phone number, information about the number of unique IPs related to a specific IMEI, information about the number of unique phone numbers related to a specific IMEI, and/or information about a sum of billing charges for first messages with respect to a specific IMEI.

6. The server of claim 1, wherein the third feature includes a feature acquired using the information related to the device and the phone number among information included in the plurality of first messages sent from a designated country during a designated time period.

7. The server of claim 1, wherein the information related to the device and the phone number, used to acquire the third feature, comprises at least one of: information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, and/or information about the number of IMEIs having an identical prefix in a designated country.

8. The server of claim 1, wherein the instructions, when executed by the at least one processor individually or collectively, cause the server to:
acquire a numerical value corresponding to the at least one feature and input the acquired numerical value to the artificial intelligence model as an input value.

9. The server of claim 1, wherein the instructions, when executed by the at least one processor individually or collectively, cause the server to:
arrange the at least one feature in an order in which the at least one feature has been used to train the artificial intelligence model, and input the arranged at least one feature to the artificial intelligence model as an input value.

10. The server of claim 1, wherein the artificial intelligence model is trained to detect an attack of an abnormal message, based on at least one of the first feature, the second feature, or the third feature.

11. A method for detecting an attack of an abnormal message, the method comprising:
based on receiving a first message for an authentication request, identifying information included in the first message;
acquiring at least one of a first feature acquired using information related to the authentication request among information included in the first message, a second feature acquired using information related to a device and a telephone number among information included in a plurality of first messages received during a designated time period, and/or a third feature acquired using information related to a device and a telephone number among information included in a plurality of first messages received from a designated country during a designated time period;
inputting the at least one feature to an artificial intelligence model as an input value; and
based on an output value output from the artificial intelligence model being greater than or equal to a threshold value, identifying the first message as an attack of an abnormal message.

12. The method of claim 11, wherein the first feature includes a feature acquired using information related to the authentication request included in a single first message.

13. The method of claim 11, wherein the information related to the authentication request, used to acquire the first feature, comprises at least one of: a billing charge of the first message, information about a device registered to a user's account at a time point of requesting authentication through the first message, information about a difference between a time point of requesting authentication through the first message and a time point at which a domain for an email was generated, and/or information about a difference between a time point of requesting authentication through the first message and a time point at which a device that sent the first message was released.

14. The method of claim 11, wherein the second feature includes a feature acquired using information related to a device and a phone number among information included in the plurality of first messages continuously received during a designated time period.

15. The method of claim 11, wherein the information related to the device and the phone number, used to acquire the second feature, comprises at least one of: information about the number of unique IPs related to a specific phone number, information about a sum of billing charges for first messages with respect to a specific phone number, information about the number of unique IPs related to a specific IMEI, information about the number of unique phone numbers related to a specific IMEI, and/or information about a sum of billing charges for first messages with respect to a specific IMEI.

16. The method of claim 11, wherein the third feature includes a feature acquired using the information related to the device and the phone number among information included in the plurality of first messages sent from a designated country during a designated time period.

17. The method of claim 11, wherein the information related to the device and the phone number, used to acquire the third feature, comprises at least one of: information about a difference between a usage rate of a domain for a specific email and an average usage rate of a domain for a specific email in a designated country during a designated time period, information about a difference between a usage rate of a specific application or service and an average usage rate of a specific application or service in a designated country during a designated time period, information about the number of phone numbers having an identical prefix in a designated country, information about the number of authentication requests through first messages using IMEIs having an identical prefix in a designated country, and/or information about the number of IMEIs having an identical prefix in a designated country.

18. The method of claim 11, further comprising acquiring a numerical value corresponding to the at least one feature and inputting the acquired numerical value to the artificial intelligence model as an input value.

19. The method of claim 11, further comprising arranging the at least one feature in an order in which the at least one feature has been used to train the artificial intelligence model, and inputting the arranged at least one feature to the artificial intelligence model as an input value.

20. A non-transitory computer-readable recording medium storing instructions which, when executed by a server, cause the server to perform at least one operation,
wherein the at least one operation comprises:
based on receiving a first message for an authentication request, identifying information included in the first message;
identifying at least one of a first feature acquired using information related to the authentication request among information included in the first message, a second feature acquired using information related to a device and a telephone number among information included in a plurality of first messages received during a designated time period, and/or a third feature acquired using information related to a device and a telephone number among information included in a plurality of first messages received from a designated country during a designated time period;
inputting the at least one feature to an artificial intelligence model as an input value; and
based on an output value output from the artificial intelligence model being greater than or equal to a threshold value, identifying the first message as an attack of an abnormal message.
